(19) United States
(12) Patent Application Publication
(10) Pub. No.: US 2025/0033477 A1
(43) Pub. Date: Jan. 30, 2025

(54) DISPLAY CONTROL DEVICE

(71) Applicant: TOYOTA JIDOSHA KABUSHIKI KAISHA, Toyota-shi (JP)

(72) Inventor: Noritaka TAKUDA, Okazaki-shi (JP)

(73) Assignee: TOYOTA JIDOSHA KABUSHIKI KAISHA, Toyota-shi (JP)

(21) Appl. No.: 18/610,511

(22) Filed: Mar. 20, 2024

(30) Foreign Application Priority Data
Jul. 25, 2023 (JP) 2023-121094

(51) Int. Cl. B60K 35/28; B60K 35/22; B60L 1/02

(52) U.S. Cl. CPC B60K 35/28; B60K 35/22; B60L 1/02; B60K 2360/167; B60K 2360/169; B60L 2240/12; B60L 2250/16; B60L 2260/52; B60L 2260/54

(57) ABSTRACT

A display control device includes a drive device for driving a drive shaft connected to an axle, and a display device for displaying information, and is used in a vehicle that is mounted on the vehicle and travels with at least one of fuel and electricity as an energy source, and displays an estimated consumption rate estimated as an energy consumption rate of a vehicle in the future on a display device, wherein an average vehicle speed of the vehicle is estimated based on a predetermined parameter reflecting a travelable distance that is a travelable distance by an amount of an energy source mounted on the vehicle, or a travelable distance, and an estimated consumption rate is calculated based on the estimated average vehicle speed.

### CROSS-REFERENCE TO RELATED APPLICATION

This application claims priority to Japanese Patent Application No. 2023-121094 filed on Jul. 25, 2023, incorporated herein by reference in its entirety.

### BACKGROUND

### 1. Technical Field

The present disclosure relates to a display control device.

### 2. Description of Related Art

Conventionally, there has been proposed, as a cruising distance calculation device that calculates a cruising distance of a vehicle, a cruising distance calculation device for use in a vehicle equipped with a power storage device (secondary battery) (see Japanese Unexamined Patent Application Publication No. 2014-64364 (JP 2014-64364 A), for example). In this device, an average vehicle speed in travel over a predetermined distance in the past is calculated, and an energy consumption rate corresponding to the average vehicle speed is derived from a table that indicates the relationship between the energy consumption rate (electric efficiency) of the vehicle and the vehicle speed. Then, the cruising distance is calculated based on the derived energy consumption rate and the power storage ratio of the power storage device.

### SUMMARY

When a display device that displays information is provided in an occupant compartment and an estimated consumption rate estimated as a future energy consumption rate of the vehicle is displayed on the display device, it is recognized as an important issue to display an estimated consumption rate calculated with high accuracy. In the above-described cruising distance calculation device, an estimated consumption rate is derived using the average vehicle speed in the past travel. The average vehicle speed in the past travel may deviate from the average vehicle speed in the future travel, and the estimated consumption rate may not be calculated with high accuracy in some cases.

It is a main object of a display control device according to the present disclosure to display an estimated consumption rate calculated with high accuracy.

In order to achieve the above-described main object, the display control device according to the present disclosure adopts the following means. A first aspect of the present disclosure provides a display control device for use in a vehicle including a drive device that drives a drive shaft connected to an axle and a display device that displays information, the vehicle traveling with at least one of a fuel and electricity mounted as an energy source, the display control device causing the display device to display an estimated consumption rate estimated as a future energy consumption rate of the vehicle, in which an average vehicle speed of the vehicle is estimated based on a predetermined parameter that reflects a travelable distance over which the vehicle is able to travel using an amount of the energy source mounted on the vehicle, and the estimated consumption rate is calculated based on the estimated average vehicle speed.

In the display control device according to the present disclosure, an average vehicle speed of the vehicle is estimated based on a predetermined parameter that reflects a travelable distance over which the vehicle is able to travel using an amount of the energy source mounted on the vehicle or based on the travelable distance, and the estimated consumption rate is calculated based on the estimated average vehicle speed. It is considered that the frequency of high-speed travel is high and the average vehicle speed is high when the travelable distance is long, compared to when the travelable distance is short. Thus, the average vehicle speed can be estimated with higher accuracy by estimating the average vehicle speed of the vehicle based on a predetermined parameter that reflects the travelable distance. Since the estimated consumption rate is calculated based on the average vehicle speed estimated in this manner, the estimated consumption rate can be calculated with higher accuracy. As a result, the estimated consumption rate calculated with high accuracy can be displayed. Here, the “predetermined parameter” may include an amount of the energy source mounted on the vehicle, an expected travel distance from the present location of the vehicle to the destination calculated by a navigation system mounted on the vehicle, a history of driving of the vehicle by the driver in the past, and the like.

In the display control device according to the first aspect of the present disclosure,
the drive device may include a motor for travel and a power storage device that exchanges power with the motor;
the predetermined parameter may be a power storage ratio of the power storage device; and
the average vehicle speed may be estimated using the power storage ratio and a predetermined relationship determined in advance as a relationship between the power storage ratio and the average vehicle speed, and an estimated electric efficiency may be calculated as the estimated consumption rate based on the average vehicle speed.

In this case, the vehicle may include an air conditioning device that operates with supply of power and that performs air conditioning in an occupant compartment; and a first electric efficiency that is an estimated value of a travel electric efficiency and a second electric efficiency that is an estimated value of an air-conditioning electric efficiency may be set based on the average vehicle speed, and the estimated electric efficiency may be calculated by adding the second electric efficiency to the first electric efficiency.

A second aspect of the present disclosure provides a display control device for use in a vehicle including a drive device that drives a drive shaft connected to an axle, an air conditioning device that performs air conditioning in an occupant compartment, and a display device that displays information, the vehicle traveling with at least one of a fuel and electricity mounted as an energy source, the display control device causing the display device to display an estimated consumption rate estimated as a future energy consumption rate of the vehicle, in which a first consumption rate as an estimated travel distance per unit energy amount and a second consumption rate as an estimated travel distance per unit energy consumed by the air conditioning device are set such that the first consumption rate is reduced and the second consumption rate is increased when an amount of the energy source mounted on the vehicle is large, compared to when the amount of the energy source is small, and a sum of the first consumption rate and the second consumption rate is set as the estimated consumption rate.

In the display control device according to the second aspect of the present disclosure, a first consumption rate as an estimated travel distance per unit energy amount and a second consumption rate as an estimated travel distance per unit energy consumed by the air conditioning device are set such that the first consumption rate is reduced and the second consumption rate is increased when an amount of the energy source mounted on the vehicle is large, compared to when the amount of the energy source is small, and a sum of the first consumption rate and the second consumption rate is set as the estimated consumption rate. The travel distance tends to be long and the frequency of high-speed travel tends to be high when the amount of the energy source mounted on the vehicle is large, compared to when the amount of the energy source is small. Therefore, the travel resistance increases, which reduces the first consumption rate. Further, when the travel distance increases, the second consumption rate is increased. Thus, a first consumption rate as an estimated travel distance per unit energy amount and a second consumption rate as an estimated travel distance per unit energy consumed by the air conditioning device are set such that the first consumption rate is reduced and the second consumption rate is increased when an amount of the energy source mounted on the vehicle is large, compared to when the amount of the energy source is small, which makes it possible to set a travel electric efficiency and an air conditioning electric efficiency with higher accuracy and calculate an estimated electric efficiency with higher accuracy. As a result, the estimated consumption rate calculated with high accuracy can be displayed.

A third aspect of the present disclosure provides a display control device for use in a vehicle including a drive device including a motor for travel and a power storage device that exchanges power with the motor, and a display device that displays information, the display control device causing the display device to display an estimated electric efficiency estimated as a future electric efficiency of the vehicle as an estimated consumption rate, in which the estimated electricity efficiency is increased when a power storage ratio of the power storage device is high, compared to when the power storage ratio is low.

In the display control device according to the third aspect of the present disclosure, the estimated electricity efficiency is increased when a power storage ratio of the power storage device is high, compared to when the power storage ratio is low. When the power storage ratio of the power storage device is high, it is considered that the travelable distance over which the vehicle is able to travel at the power storage ratio of the power storage device is long, compared to when the power storage ratio is low. When the travelable distance is long, it is considered that the frequency of high-speed travel is high and the electric efficiency is high, compared to when the travelable distance is short. Thus, when the power storage ratio of the power storage device is high, the estimated electric efficiency, that is, the estimated consumption rate, can be set with higher accuracy by increasing the estimated electric efficiency, compared to when the power storage ratio is low. As a result, the estimated consumption rate can be displayed with higher accuracy.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a battery electric vehicle 20 equipped with a display control device according to the present embodiment;

FIG. 2 is a flowchart illustrating an example of a display routine;

FIG. 3 is an explanatory diagram illustrating an exemplary relation between the power storage ratio SOC and the average vehicle speed Vav; and

FIG. 4 is an explanatory diagram illustrating an exemplary relation between the travelable distance Rd and the average vehicle speed Vav.

### DETAILED DESCRIPTION OF EMBODIMENTS

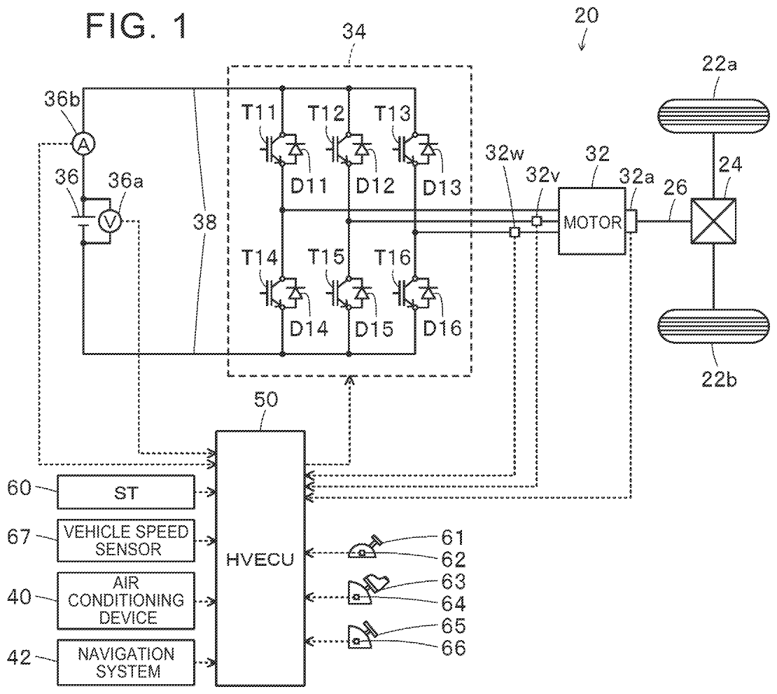

Embodiments of the present disclosure will be described with reference to the drawings. FIG. 1 is a schematic configuration diagram of a battery electric vehicle 20 equipped with a display control device according to the present embodiment. As illustrated, battery electric vehicle 20 of the present embodiment includes a traveling motor 32, an inverter 34, a battery 36 as a power storage device, an air conditioning device 40, a navigation system 42, and an electronic control unit (hereinafter, referred to as “ECU”) 50.

The motor 32 is configured as a synchronous generator motor, and includes a rotor in which a permanent magnet is embedded in a rotor core, and a stator in which a three-phase coil is wound around the stator core. The rotor of the motor 32 is connected to a drive shaft 26 connected to the drive wheel 22a, 22b via a differential gear 24.

The inverter 34 is used to drive the motor 32 and is connected to the power line 38 together with the battery 36. Inverter 34 includes transistors T11 to T16 as six switching elements, and six diodes D11 to D16 connected in parallel to T16 from six transistors T11. Transistor T11 to T16, respectively, are arranged in pairs of two so as to be the source side and sink side with respect to the positive side line and the negative side line of the power line 38. Each of the connecting points of the transistors which are the pair of the transistors T11 to T16 is connected to each of the three-phase (U-phase, V-phase, and W-phase) coils of the motor 32. Therefore, when a voltage is applied to the inverter 34, the ratio of the on-time of T16 from the pair of transistors T11 is adjusted by ECU 50, so that a rotating magnetic field is formed in the three-phase coil, and the motor 32 is rotationally driven.

The battery 36 is configured as, for example, a lithium ion secondary battery or a nickel hydrogen secondary battery having a rated voltage of about several hundred V, and is connected to the power line 38 together with the inverter 34 as described above.

The air conditioning device 40 is configured as a device for conditioning the air in the passenger compartment. The air conditioning device 40 is operated by electric power from an auxiliary battery (not shown) having a lower rated power than the battery 36 or the battery 36. The air conditioning device 40 is controlled by an ECU 50.

The navigation system 42 is a system that guides the host vehicle to a set destination, and includes a map information database (not shown) and a display unit. The map information database stores, as map information, the road surface pavement state of the road in each section, the width of the road, the number of lanes, the width of the sidewalk, the direction in which the vehicle can pass, the legal speed, and the like. When the destination is set, the navigation system 42 sets a route based on the information of the destination and the information of the current location (the current location of the own vehicle) acquired by GPS and the information stored in the map information database, and performs route guidance.

ECU 50 includes a microcomputer, and the microcomputer includes a CPU, a ROM, RAM, a flash memory, an input/output port, and a communication port. ECU 50 receives signals from various sensors via input ports. For example, ECU 50 receives a rotational position Om from a rotational position sensor (for example, a resolver) 32a that detects the rotational position of the rotor of the motor 32, and a phase current Iv, Iw from a current sensor 32v, 32w that detects the V-phase and W-phase currents of the motor 32. A voltage Vb from a voltage sensor 36v attached between terminals of the battery 36 and a current Ib from a current sensor 36i attached to an output terminal of the battery 36 are also inputted. A start signal from the start switch 60, a shift position SP from the shift sensor 62 for detecting an operation position of the shift lever 61, an accelerator operation amount Acc from the accelerator sensor 64 for detecting a depression amount of the accelerator pedal 63, a brake pedal position from the brake sensor 66 for detecting a depression amount of the brake pedal 65, and a vehicle speed V from the vehicle speed sensor 67 are also inputted.

ECU 50 outputs various control signals via an output port. For example, ECU 50 outputs a display device 70 for displaying control signals and information to the plurality of switching elements of the inverter 34. ECU 50 calculates the motor 32 and the rotational speed Nm based on the control rotational position θmc based on the rotational position θm of the rotor of the motor 32 from the rotational position sensor 32a. The power storage ratio SOC of the battery 36 is also calculated based on the integrated value of the current Ib. The power storage ratio SOC is a ratio of dischargeable power to the total capacity of the battery 36.

In battery electric vehicle 20 equipped with the display control device of the present embodiment configured as described above, ECU 50 sets the required torque Td* (required for the drive shaft 26) required for traveling based on the accelerator operation amount Acc and the vehicle speed V, sets the set required torque Td* to the torque command Tm* of the motor 32, and performs switching control of the plurality of switching elements of the inverter 34 so that the motor 32 is driven by the torque command Tm*.

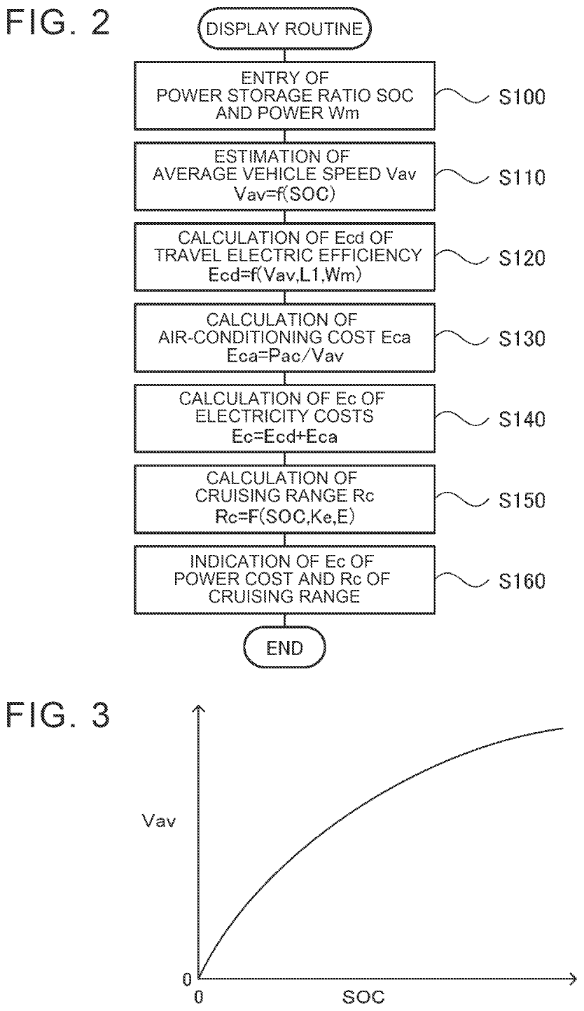

Next, the operation of battery electric vehicle 20 equipped with the display control device of the present embodiment configured in this way, in particular, the estimated electric efficiency (estimated consumption rate) as an estimated value of the power cost (energy consumption rate) of the vehicle in the future and the operation when displaying the travelable distance in the passenger compartment will be described. FIG. 2 is a flow chart illustrating an exemplary process executed by ECU 50 according to the present embodiment. After the start switch 60 is turned on to start battery electric vehicle 20 system, the routine is executed once per trip (the time from system start to system stop).

When this routine is executed, a CPU (not shown) of ECU 50 executes a process of inputting the power storage ratio SOC and the power quantity Wm of the motor 32 (S100). The power storage ratio SOC is calculated based on the integrated value of the current Ib. Electric energy Wm is the electric energy of the motor 32 when the vehicle travels a predetermined time T1 (e.g., 2 minutes, 3 minutes, 5 minutes, etc.), and it is assumed that a product obtained by multiplying a value obtained by subtracting power Pac consumed by the air conditioning device 40 from the charge and discharge power Pb of the battery 36 obtained as a product of the voltage Vb of the battery 36 from the voltage sensor 36a and the current Ib of the battery 36 from the current sensor 36b during the predetermined time T1, by the predetermined time T1, is entered. The traveling power Pd may be calculated as the product of the torque command Tm* and the rotational speed Nm of the motor 32.

Subsequently, the average vehicle speed Vav as the average vehicle speed V in the future travel is estimated based on the power storage ratio SOC (S110). S110 obtains the relationship between the power storage ratio and the average vehicle speed in advance by experimentation, machine learning, or the like, and when the power storage ratio SOC is given, estimates the average vehicle speed corresponding to the power storage ratio SOC as the average vehicle speed Vav from the relationship (predetermined relationship) between the power storage ratio and the average vehicle speed. FIG. 3 is an explanatory diagram illustrating an exemplary relation between the power storage ratio SOC and the average vehicle speed Vav. As shown in the figure, the average vehicle speed Vav is higher when the power storage ratio SOC is higher than when the power storage ratio is lower. This is based on the fact that the travelable distance Rd as the travelable distance is longer with the amount of electric power dischargeable from the battery 36 than when the power storage ratio SOC is higher, and the frequency of high-speed traveling is higher and the average vehicle speed Vav is considered higher when the travelable distance Rd is longer than when the power storage ratio is shorter. By estimating the average vehicle speed Vav based on the power storage ratio SOC in this way, the average vehicle speed Vav can be estimated more accurately.

Subsequently, a travel electric efficiency (first electricity cost, first consumption rate) Ecd as an estimated travel electric efficiency in the future traveling is calculated (S120). The travel electric efficiency Ecd is a traveling distance per unit discharged electric power (unit energy amount) of the battery 36. The travel electric efficiency Ecd is calculated by multiplying the basic Ecdb of the travel electric efficiency by a factor K set to be smaller than when the average vehicle speed Vav is large. Therefore, the travel electric efficiency Ecd becomes smaller when the average vehicle speed Vav is large than when it is small. This is based on the fact that the travel electric efficiency decreases because the traveling drag is larger than that when the average vehicle speed Vav is large and small.

Subsequently, an air conditioning electric efficiency (second electricity cost, second consumption rate) Eca as an estimated value of the air conditioning electric efficiency in the running from now on is calculated (S130). The air conditioning electric efficiency Eca is the travel distance of battery electric vehicle 20 per unit power consumption (unit energy consumption) of the air conditioning device 40. The air conditioning electric efficiency Eca is calculated by dividing battery electric vehicle 20 by the predetermined time T2 of the air conditioning device 40 the distance L2 traveled T2 the predetermined time by Whca of power consumed. Here, the distance L2 is calculated by multiplying the average vehicle speed Vav by the predetermined time T2, and the power consumption Whca is calculated by multiplying the average power consumption Pa of the air conditioning device 40 by the predetermined time T2. Therefore, the air conditioning electric efficiency Eca is calculated by dividing the average vehicle speed Vav by the average power-consumption Pa, and becomes larger when the average vehicle speed Vav is higher than when the average vehicle speed is lower.

After calculating the travel electric efficiency Ecd and the air conditioning electric efficiency Eca in this manner, the travel electric efficiency Ecd plus the air conditioning electric efficiency Eca is calculated as the estimated electric efficiency Ec of battery electric vehicle 20 (S140). Since the estimated electric efficiency Ec is calculated by using the average vehicle speed Vav accurately estimated in this way, the estimated electric efficiency Ec can be calculated more accurately.

Then, the power storage ratio SOC of the battery 36 is multiplied by the conversion coefficient ke to convert the power storage ratio SOC of the battery 36 into the power amount Wbsoc dischargeable from the battery 36, and the power amount Wbsoc is divided by the estimated electric efficiency Ec to calculate the travelable distance Rd (S150), and the calculated estimated electric efficiency Ec and the travelable distance Rd are displayed on the display device 70 (S160), and this routine is ended. Since the travelable distance Rd is accurately calculated using the estimated electric efficiency Ec, the travelable distance Rd can be accurately calculated. As a result, the estimated electric efficiency Ec and the travelable distance Rd calculated with high accuracy can be displayed on the display device 70.

According to battery electric vehicle 20 equipped with the display control device of the embodiment described above, it is possible to display the estimated electric efficiency Ec accurately calculated by estimating the average vehicle speed Vav of battery electric vehicle 20 based on the power storage ratio SOC and calculating the estimated electric efficiency Ec based on the estimated average vehicle speed Vav.

In addition, the estimated electric efficiency Ec can be accurately calculated by estimating the average vehicle speed Vav using the power storage ratio SOC and a relation determined in advance as a relation between the power storage ratio SOC and the average vehicle speed Vav, and calculating the estimated electric efficiency Ec based on the average vehicle speed Vav.

Further, battery electric vehicle 20 has an air conditioning device 40 that operates by being supplied with electric power to perform air-conditioning in the passenger compartment, sets the travel electric efficiency Ecd and the air conditioning electric efficiency Eca based on the average vehicle speed Vav, and calculates the estimated electric efficiency Ec by adding the air conditioning electric efficiency Eca to the travel electric efficiency Ecd, whereby the estimated electric efficiency Ec can be calculated more appropriately.

In the above-described embodiment, the average vehicle speed Vav is estimated based on the power storage ratio SOC, and the estimated electric efficiency Ec is calculated based on the average vehicle speed Vav. However, the estimated electric efficiency Ec may be calculated without estimating the average vehicle speed Vav based on the power storage ratio SOC. When the power storage ratio SOC is higher, the estimated electric efficiency Ec may be set larger than when the power storage ratio is lower.

In the above-described embodiment, the travel electric efficiency Ecd is set to be smaller than when the average vehicle speed Vav is large. However, when the power storage ratio SOC is large, the average vehicle speed Vav increases as compared with when the power storage ratio is small, and therefore, the travel electric efficiency Ecd may be set to be larger than when the power storage ratio SOC is large as compared with when the power storage ratio is small.

In the above-described embodiment, the air conditioning electric efficiency Eca is set to be larger than when the average vehicle speed Vav is large and smaller. However, when the power storage ratio SOC is large, the average vehicle speed Vav becomes larger than when the power storage ratio is small, and therefore, the air conditioning electric efficiency Eca may be set to be smaller than when the power storage ratio is small when the power storage ratio SOC is large.

In the above-described embodiment, the travel electric efficiency Ecd and the air conditioning electric efficiency Eca are calculated, and the estimated electric efficiency Ec is calculated by adding the air conditioning electric efficiency Eca to the calculated travel electric efficiency Ecd. However, in addition to the travel electric efficiency Ecd and the air-conditioning electricity cost Eca, the estimated electric efficiency Ec may be calculated by adding the auxiliary electricity cost as the traveling distance per unit energy consumption of the auxiliary machinery other than the battery 36 and the air conditioning device 40 consuming electricity of the auxiliary machinery battery. The auxiliary electrical cost can be calculated by dividing the average vehicle speed Vav by the average power consumed by the auxiliary devices. In addition, when battery electric vehicle 20 is equipped with the photovoltaic power generation system capable of charging the battery 36, the estimated electric efficiency Ec may be calculated by adding, in addition to the travel electric efficiency Ecd and the air conditioning electric efficiency Eca, the solar charged electric power cost as the traveling distance per unit power generation amount of the photovoltaic power generation system. The solar charge cost can be calculated by dividing the average vehicle speed Vav by the average charge power of the photovoltaic power generation system. Further, as the estimated electric efficiency Ec, a learned electricity cost Ecdl obtained by learning for each trip may be used. The learned electricity cost Ecdl is calculated by the following equation (1) when the start switch 60 is turned off and the system is stopped. In Expression (1), “Ecd” is the electric charge in the current trip, and is calculated by dividing the travel distance in the current trip by the energy consumed in the travel in the current trip (discharged power of the battery 36). The “previous Ecdl” is Ecdl of learned electricity costs up to the previous trip. “A” is a value determined in advance as a learning reflection rate. “Al” is the rate of reflection of the electricity cost calculated in the current trip into the learned electricity cost Ecdl. “k” is the gain.

Ecdl=(1−A)·Last Ecdl+A·((1−A1)·Last Ecdl+A1·Ecd·k) (1)

In the above-described embodiment, when the power storage ratio SOC is large, the average vehicle speed Vav becomes larger than when the power storage ratio is small. However, when the power storage ratio SOC is large, the average vehicle speed Vav may be made smaller than when the power storage ratio SOC is small in battery electric vehicle of types in which the average vehicle speed Vav is made smaller than when the power storage ratio is small.

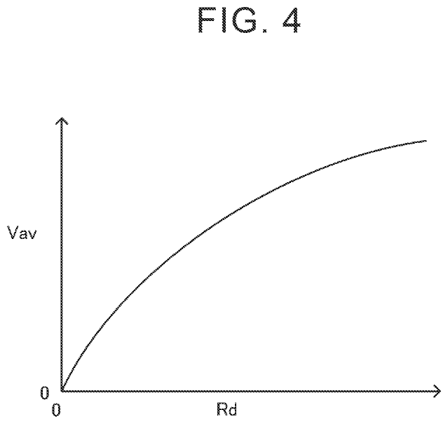

In the above-described embodiment, the average vehicle speed Vav is estimated based on the power storage ratio SOC. However, instead of the power storage ratio SOC or together with the power storage ratio SOC, the average vehicle speed Vav may be estimated on the basis of a predetermined parameter that reflects a travelable distance Rd in an amount of an energy source mounted on the vehicle, such as an expected travel distance from the current position of battery electric vehicle 20 calculated in the navigation system 69 to the destination, or a driving history when the driver drives battery electric vehicle 20 in the past. In addition, the travelable distance Rd may be used instead of the predetermined parameter. FIG. 4 is an explanatory diagram illustrating an exemplary relation between the travelable distance Rd and the average vehicle speed Vav. As shown in the figure, when the travelable distance Rd is large, the average vehicle speed Vav becomes larger than when the travelable distance is small. This is based on the fact that the frequency of high-speed traveling is higher when the travelable distance Rd is large than when it is small. In this way, the average vehicle speed Vav can be set more accurately by setting the average vehicle speed Vav so that the average vehicle speed Vav becomes larger when the travelable distance Rd is large than when the travelable distance is small.

In the above-described embodiment, the display control device of the present disclosure is applied to a battery electric vehicle 20 that drives a drive shaft 26 connected to an axle by power from a motor 32. However, the display control device of the present disclosure may be applied to an automobile including a drive device that drives the drive shaft 26 by power from an engine instead of the motor 32. In this case, the average vehicle speed of the vehicle may be estimated based on the amount of fuel in the fuel tank, and the fuel consumption may be calculated using the estimated average vehicle speed. In this case, when the amount of fuel is large, the average vehicle speed may be set to be larger than when the amount of fuel is small. Further, when the amount of fuel is large, the running fuel efficiency may be set to be smaller than when the amount of fuel is small, and the air-conditioning fuel efficiency may be set to be larger, and the air-conditioning fuel efficiency may be added to the set running fuel efficiency to calculate the fuel efficiency. Further, the display control device of the present disclosure may be applied to a hybrid electric vehicle or the like including a drive device that drives the drive shaft 26 by power from an engine and a motor.

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the embodiments for carrying out the present disclosure have been described above, the present disclosure is not limited to such embodiments at all, and it is needless to say that the present disclosure can be carried out in various forms without departing from the gist of the present disclosure.

The present disclosure is applicable to a manufacturing industry of a display control device and the like.

What is claimed is:

1. A display control device for use in a vehicle including a drive device that drives a drive shaft connected to an axle and a display device that displays information, the vehicle traveling with at least one of a fuel and electricity mounted as an energy source, the display control device causing the display device to display an estimated consumption rate estimated as a future energy consumption rate of the vehicle, wherein an average vehicle speed of the vehicle is estimated based on a predetermined parameter that reflects a travelable distance over which the vehicle is able to travel using an amount of the energy source mounted on the vehicle or based on the travelable distance, and the estimated consumption rate is calculated based on the estimated average vehicle speed.

2. The display control device according to claim 1, wherein:
the drive device includes a motor for travel and a power storage device that exchanges power with the motor;
the predetermined parameter is a power storage ratio of the power storage device; and
the average vehicle speed is estimated using the power storage ratio and a predetermined relationship determined in advance as a relationship between the power storage ratio and the average vehicle speed, and an estimated electric efficiency is calculated as the estimated consumption rate based on the average vehicle speed.

3. The display control device according to claim 2, wherein:
the vehicle may include an air conditioning device that operates with supply of power and that performs air conditioning in an occupant compartment; and
a first electric efficiency that is an estimated value of a travel electric efficiency and a second electric efficiency that is an estimated value of an air-conditioning electric efficiency are set based on the average vehicle speed, and the estimated electric efficiency is calculated by adding the second electric efficiency to the first electric efficiency.

4. A display control device for use in a vehicle including a drive device that drives a drive shaft connected to an axle, an air conditioning device that performs air conditioning in an occupant compartment, and a display device that displays information, the vehicle traveling with at least one of a fuel and electricity mounted as an energy source, the display control device causing the display device to display an estimated consumption rate estimated as a future energy consumption rate of the vehicle, wherein a first consumption rate as an estimated travel distance per unit energy amount and a second consumption rate as an estimated travel distance per unit energy consumed by the air conditioning device are set such that the first consumption rate is reduced and the second consumption rate is increased when an amount of the energy source mounted on the vehicle is large, compared to when the amount of the energy source is small, and a sum of the first consumption rate and the second consumption rate is set as the estimated consumption rate.

5. A display control device for use in a vehicle including a drive device including a motor for travel and a power storage device that exchanges power with the motor, and a display device that displays information, the display control device causing the display device to display an estimated electric efficiency estimated as a future electric efficiency of the vehicle, wherein the estimated electricity efficiency is increased when a power storage ratio of the power storage device is high, compared to when the power storage ratio is low.
